(19) United States
(12) Patent Application Publication
(10) Pub. No.: US 2020/0180914 A1
(43) Pub. Date: Jun. 11, 2020

(54) METHODS AND APPARATUSES FOR LIFTING ELEVATOR CARS DURING INSTALLATION

(71) Applicants: ThyssenKrupp Elevator Corporation, Alpharetta, GA (US); thyssenkrupp AG, Essen (DE)

(72) Inventor: William E. Bowling, Bloomington, IN (US)

(73) Assignees: ThyssenKrupp Elevator Corporation, Alpharetta, GA (US); thyssenkrupp AG, Essen (DE)

(21) Appl. No.: 16/212,001

(22) Filed: Dec. 6, 2018

(51) Int. Cl. B66B 19/00; B66B 11/00; B66B 11/06

(52) U.S. Cl. CPC B66B 19/00; B66B 11/06; B66B 11/005

(57) ABSTRACT

Climber motors are a form of temporary winch that can be used before a permanent elevator drive system is installed at the top of a hoistway. A mount to be employed with such a climber motor may include a frame having a base, a lower portion, and an upper portion. The upper portion may support a lower plate, which lower plate supports sleeves, which sleeves in turn support an upper plate. The frame and the climber motor may be positioned within an elevator cab such that the sleeves extend upwards through apertures in a canopy of the elevator cab. Once the upper plate is positioned between the sleeves and a crosshead above the elevator cab, the climber motor may be engaged to cause the sleeves to exert an upward force on the crosshead and thereby lift the elevator cab in the hoistway.

### FIELD OF THE DISCLOSURE

The present disclosure generally relates to elevators, including methods and apparatuses for lifting elevator cars during installation of elevator systems prior to installment of a permanent elevator machine.

### BACKGROUND

A car sling is the basic frame that is used to support a platform and a cab of an elevator. The car sling typically includes a pair of stiles extending vertically alongside the cab, a crosshead that connects the stiles above the cab, and a safety plank that connects the stiles beneath the platform and the cab. Of course the car sling may include other components such as brace rods that provide rigidity to the car sling and extend diagonally between the platform and the stiles, for example.

Furthermore, advantages are known to roping an elevator car at a top, as opposed to a bottom, of a hoistway. Quite often, the car sling is assembled at the bottom of the hoistway and then hoisted by a climber motor, which acts as a form of temporary winch, to the top of the hoistway to be roped. Many elevator manufacturers also use the climber motor to hoist a permanent elevator drive system with the car sling so that the permanent elevator drive system can be installed at the top of the hoistway just prior to roping the car sling. One advantage of using such a climber motor is that a canopy of the cab may serve as a convenient work deck that supports installers as the permanent elevator drive system is secured to a hoist beam, for example, at the top of the hoistway. Notwithstanding, during this part of the elevator installation, best practices require that the car sling be positively supported via multiple, redundant systems at the top of the hoistway to minimize the risk of the car sling dropping.

One known method for roping the car sling and installing the permanent elevator drive system involves positioning a climber motor directly above a crosshead of the car sling. The climber motor thus exerts an upward force on the crosshead to raise the car sling to the top of the hoist way. Yet with this method the climber motor consumes a considerable amount of the limited space on the work deck above the canopy. The climber motor can become even more of an obstacle once the car sling approaches the hoist beam, especially for elevator systems that do not have machine rooms. In some instances, the climber motor can interfere with the hoist beam, preventing the car sling from being positioned at a proper height where the car sling can be roped to the permanent elevator drive system.

Another known method involves attaching the climber motor to the safety plank beneath the car sling. One disadvantage of this approach, however, is that the top of the car sling can become unstable and sway left-and-right and/or back-and-forth. Such instability can become particularly problematic if installers that are supported by the canopy at the top of the car sling are installing guide rails and the like as the car sling is hoisted.

Still another known method involves attaching the climber motor and a bracket, which is used as a point of termination, to the top of the canopy of the cab. A hoist cable may then be secured to a hoist beam at the top of the hoistway. To permit the car sling to be positioned with sufficient proximity to the permanent elevator drive system, the climber motor and the bracket are then removed as the car sling is roped to the permanent elevator drive system. If repairs to the permanent elevator drive system become necessary, though, the climber motor and the bracket must then be reinstalled to suspend the car sling from the hoist beam.

Thus a need exists for methods and apparatuses that enable elevator car slings and other equipment to be lifted and installed in hoistways without the disadvantages described above.

### BRIEF DESCRIPTION OF THE DRAWINGS

FIG. 1 is a perspective view of an example mount for a climber motor.

FIG. 2 is a perspective view of the example mount of FIG. 1 extending upwards through a canopy of an elevator cab.

FIG. 3 is a perspective view of example sleeves of the example mount of FIGS. 1-2 and a hoist cable coupled to the climber motor extending upwards through the canopy of the elevator cab.

FIG. 4 is a perspective view of the example sleeves of the example mount of FIGS. 1-3 extending above the canopy of the elevator cab and secured to an example crosshead.

FIG. 5 is a perspective view of the example mount of FIGS. 1-4 secured to the crosshead, with an example guard disposed around the hoist cable that extends upwards to a top of a hoistway.

FIG. 6 is a cross-sectional schematic view of the example mount of claims 1-5, which passes through the canopy of the elevator cab and is secured to the crosshead.

### DETAILED DESCRIPTION

Although certain example methods and apparatuses are described herein, the scope of coverage of this patent is not limited thereto. On the contrary, this patent covers all methods, apparatuses, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claim need not necessarily be performed in the order in which they are recited, unless so required by the context of the claims. In addition, all references to one skilled in the art shall be understood to refer to one having ordinary skill in the art.

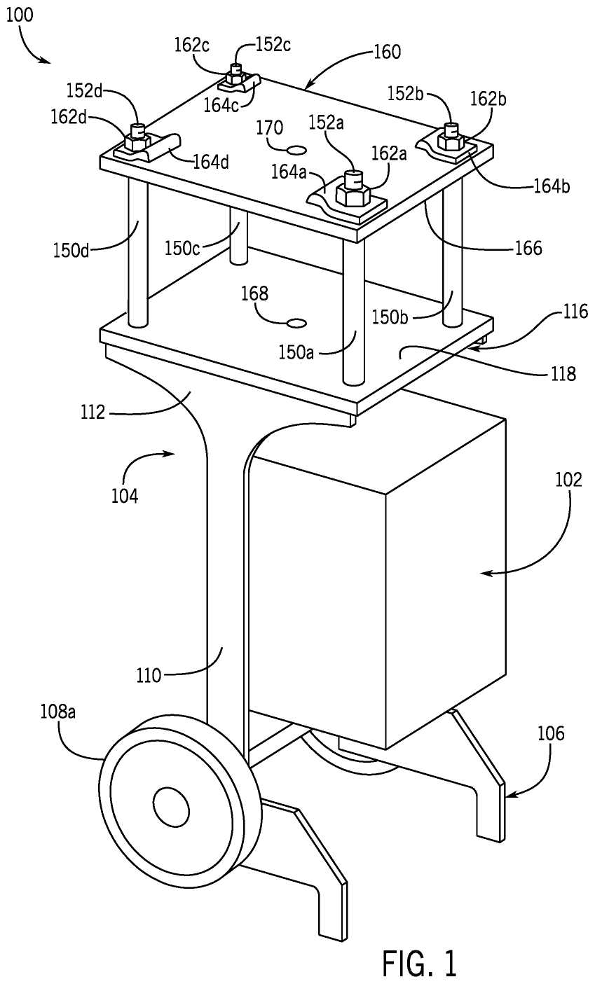

Referring now to FIG. 1, in some examples a mount 100 for a climber motor 102 may comprise a frame 104 that is supported by a base 106. In some cases, the frame 104 may also be supported by wheels 108a, 108b that enhance the transportability of the mount 100. In the example shown in FIG. 1, a lower portion 110 of the frame 104 has a thin, elongated rectangular cross section that extends upward from the base 106. In other examples, the lower portion 110 of the frame 104 may have a completely different configuration, such as a ladder-like configuration or a lattice-like configuration. The lower portion 110 may include a plurality of attachment points, apertures, or the like to which components such as the climber motor 102, for example, can be secured. An upper portion 112 of the frame 104 may include means such as a handle by which the mount 100 can be maneuvered. The upper portion 112 may serve to transition from the lower portion 110 of the frame 104 to a lower plate 116 of the mount 100. The lower plate 116 may be secured in a variety of ways to the upper portion 112 of the frame 104 such as by fasteners or welds, for example.

In some examples, such as that shown in FIG. 1, the mount 100 may include sleeves 150a, 150b, 150c, 150d that extend upwards from and are supported by a top surface 118 of the lower plate 116. In still other examples, however, the mount 100 need not necessarily include the lower plate 116, and the sleeves 150a, 150b, 150c, 150d may extend upwards from a top surface of the upper portion 112 of the frame 104. Alternatively, the lower plate 116 may be integral with the top surface of the upper portion 112 of the frame 104 such that the top surface of the upper portion 112 of the frame 104 is referred to as a lower plate. Along these lines, the upper portion 112 of the frame 104 may be said to include the lower plate 116. Nonetheless, bolts 152a, 152b, 152c, 152d may be positioned within the sleeves 150a, 150b, 150c, 150d and may extend downwards through respective apertures in the lower plate 116.

In some examples, the sleeves 150a, 150b, 150c, 150d may include bushings or other means for locating the bolts 152a, 152b, 152c, 152d centrally within the sleeves 150a, 150b, 150c, 150d and/or preventing the bolts 152a, 152b, 152c, 152d from rubbing, clanking, or otherwise pressing against the sleeves 150a, 150b, 150c, 150d. Further, in some instances, the apertures in the lower plate 116 that receive the bolts 152a, 152b, 152c, 152d may be counterbored to help locate and maintain the positions of the sleeves 150a, 150b, 150c, 150d. The bolts 152a, 152b, 152c, 152d may be secured to the lower plate 116 and/or the upper portion 112 of the frame 104 by way of, for example, nuts. In still other examples, the mount 100 may include a different number of sleeves (e.g., one, two, three, five, six, seven, etc.) and/or different types of sleeves, such as solid sleeves that are welded to either the lower plate 116 and/or the upper portion 112 of the frame 104. As merely one example, a single sleeve may be made large and/or strong enough so that no other sleeves are necessary. The single sleeve could have an internal channel that is big enough to receive a hoist cable. In such an example, an aperture in a canopy of an elevator cab could be sized to accommodate the single sleeve.

With continued reference to FIG. 1, the sleeves 150a, 150b, 150c, 150d may support an upper plate 160. The bolts 152a, 152b, 152c, 152d may extend through respective apertures in the upper plate 160 and may receive nuts 162a, 162b, 162c, 162d and washers 164a, 164b, 164c, 164d, for example, during assembly. The apertures in the upper plate 160, particularly with respect to a lower surface 166 of the upper plate 160 that is supported by the sleeves 150a, 150b, 150c, 150d, may be counterbored in some cases to help locate and maintain the positions of the sleeves 150a, 150b, 150c, 150d.

Moreover, the lower plate 116 may include an aperture 168 configured to receive a hoist cable connected to or configured to be connected to the climber motor 102. The upper plate 160 may also include an aperture 170 configured to receive the hoist cable. As those having ordinary skill in the art will appreciate, the aperture 168 in the lower plate 116 may be aligned vertically with the aperture 170 in the upper plate 160. In some instances, such as where it is desirable to double the lifting capacity of the climber motor 102 by way of 2:1 rigging, for example, the lower and upper plates 116, 160 may each include at least one additional aperture so that a hoist cable may be secured around a hoist beam at a top of the hoistway and back to the mount 100. Yet in other instances, 2:1 rigging may be accomplished by securing the hoist cable to part of a car sling such as a crosshead.

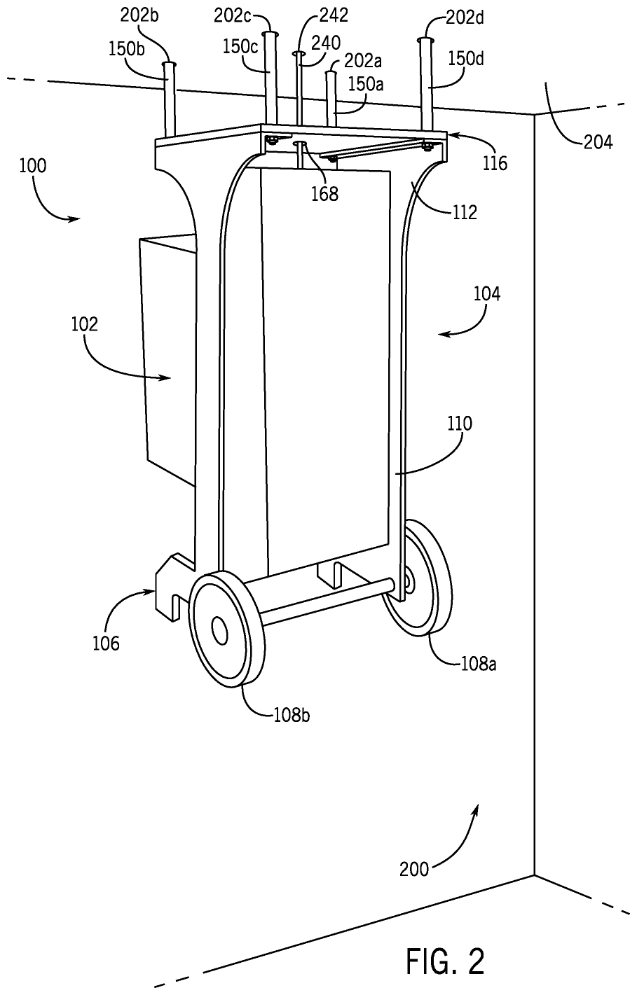

The example mount 100 may be used to lift a car sling, and in some cases other equipment such as a permanent elevator drive system and a machine installation toolkit for installing the permanent elevator drive system, to a top of a hoistway to be roped. In some methods, the mount 100 may be positioned within an elevator cab 200, and the nuts 162a, 162b, 162c, 162d and the washers 164a, 164b, 164c, 164d may be removed to permit removal of the upper plate 160 from the bolts 152a, 152b, 152c, 152d. The mount 100 may then be raised so that the bolts 152a, 152b, 152c, 152d and the sleeves 150a, 150b, 150c, 150d extend upwards through apertures 202a, 202b, 202c, 202d in a canopy 204 of the elevator cab 200, as shown in FIG. 2. It should be understood that in some examples the length of the bolts 152a, 152b, 152c, 152d and the sleeves 150a, 150b, 150c, 150d may be considerably longer such that the mount 100 may only need to be raised very little to cause the bolts 152a, 152b, 152c, 152d and the sleeves 150a, 150b, 150c, 150d to extend upwards through the apertures 202a, 202b, 202c, 202d in the canopy 204.

Notwithstanding, the present disclosure contemplates a wide variety of ways in which the mount 100 may be raised. For example and without limitation, the mount 100 may be raised manually by installers. The mount 100 may be raised by way of a jack, a lever, a pulley, or a sling. The base 106 or the frame 104 of the mount 100 may include telescoping legs that permit the mount 100 to be raised in a stable manner. Likewise, the present disclosure contemplates a wide variety of ways in which the mount 100 can be held in position once the mount 100 is raised, thereby permitting installers to secure the bolts 152a, 152b, 152c, 152d and the sleeves 150a, 150b, 150c, 150d as explained below. As one example, a support that rests on a floor of the elevator cab 200 may be slid in underneath the mount 100.

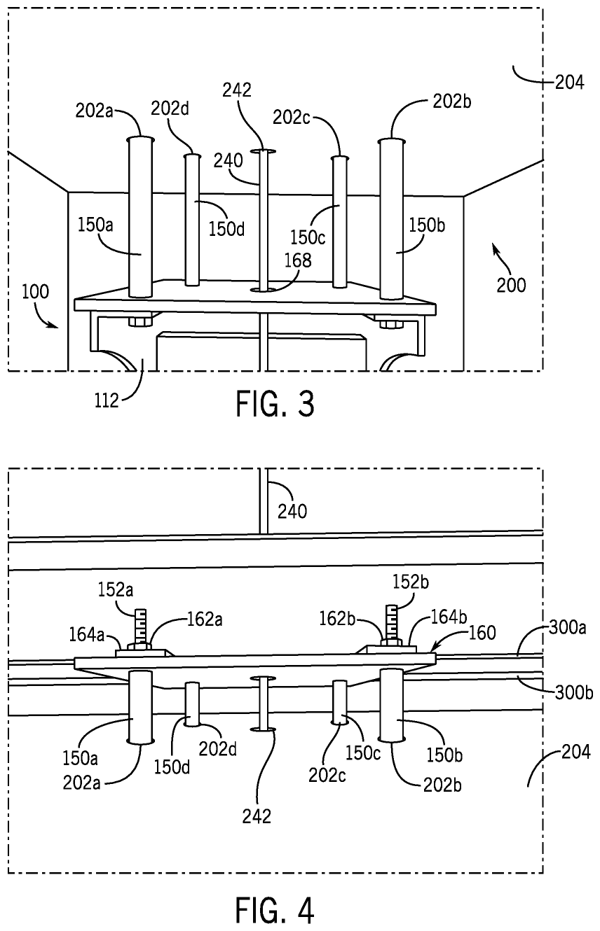

FIG. 3 shows in more detail how the sleeves 150a, 150b, 150c, 150d may be positioned so as to extend through the apertures 202a, 202b, 202c, 202d in the canopy 204. Also shown in FIG. 3 is a hoist cable 240 that has been routed to extend through an aperture 242 in the canopy 204. Depending on the climber motor 102 amongst other considerations, in some examples the hoist cable 240 may be routed from the climber motor 102 on the mount 100 up through the canopy 204, whereas in other examples the hoist cable 240 may be routed from above, down through the canopy 204 and secured to the climber motor 102 on the mount 100.

FIG. 4 shows one example arrangement of the bolts 152a, 152b, 152c, 152d and the sleeves 150a, 150b, 150c, 150d above the canopy 204. According to some example methods, once the sleeves 150a, 150b, 150c, 150d and the bolts 152a, 152b, 152c, 152d are inserted through the apertures 202a, 202b, 202c, 202d in the canopy 204, the bolts 152a, 152b, 152c, 152d may be guided through corresponding apertures in the upper plate 160 such that the sleeves 150a, 150b, 150c, 150d support the upper plate 160. The upper plate 160 and the bolts 152a, 152b, 152c, 152d—and the mount 100 generally—may then be secured to a crosshead.

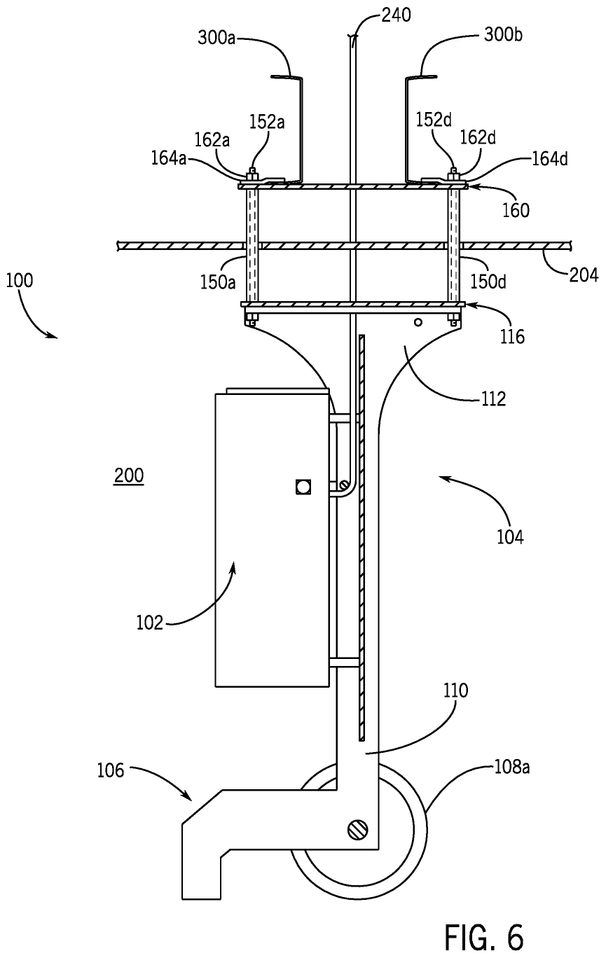

In the example shown in the figures, the crosshead of the car sling is a two-part crosshead comprised of a first crosshead 300a and a second crosshead 300b (shown better in FIG. 6). As also shown in the example in the figures, the crossheads 300a, 300b may be structural “C” channel beams with “C” shaped cross sections. Those having ordinary skill in the art will understand that in other examples, the car sling may include a different number of crossheads, such as one crosshead or three crossheads, for instance, and/or different types of beams with different cross sections. Nevertheless, FIG. 4 illustrates one example way in which the first crosshead 300a may be secured by way of clamping between the upper plate 160 on one side, and the washers 164a, 164b and the nuts 162a, 162b on the other side.

Although not shown in FIG. 4, the second crosshead 300b may be secured by way of clamping between the upper plate 160 on one side, and the washers 164c, 164d and the nuts 162c, 162d on the other side. Lateral movement between the upper plate 160 and the first and second crossheads 300a, 300b may be prevented by positioning the bolts 152a, 152b, 152c, 152d on both sides of the first and second crossheads 300a, 300b. Consequently, the mount 100 is secured to the crossheads 300a, 300b of the car sling, and the hoist cable 240 can be routed between the first and second crossheads 300a, 300b to a hoist beam at the top of the hoistway. It should be understood that the bolts 152a, 152b, 152c, 152d and/or the sleeves 150a, 150b, 150c, 150d may be secured to a crosshead in a many different ways. By way of example, one example crosshead may include corresponding apertures through which the bolts 152a, 152b, 152c, 152d extend. Some example crossheads may even have apertures in both the lower and upper lateral portions for receiving the bolts 152a, 152b, 152c, 152d.

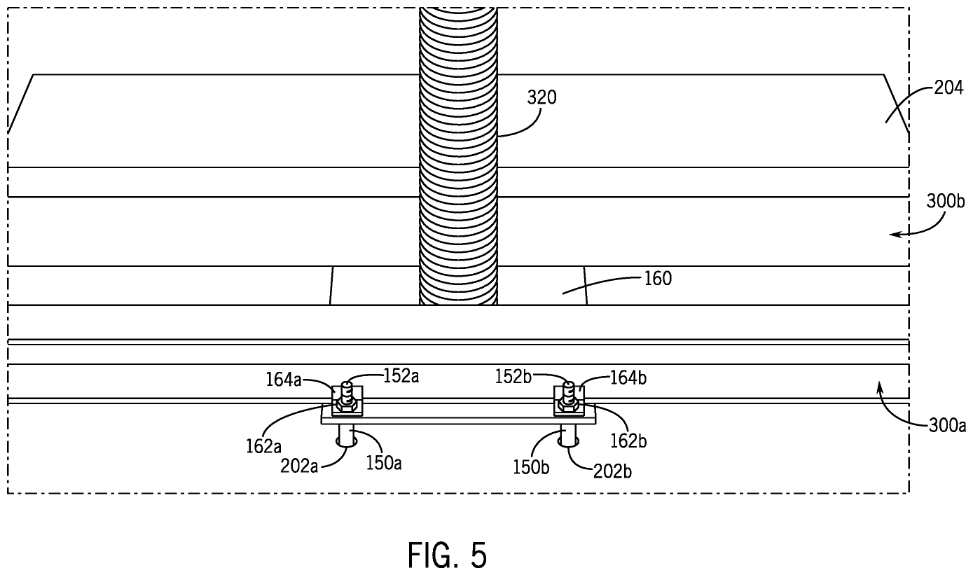

FIG. 5 provides another perspective view above the canopy 204, after the mount 100 has been secured to the first and second crossheads 300a, 300b. In FIG. 5, moreover, an example guard 320 has been placed around the hoist cable 240 to protect the hoist cable 240 during certain parts of the elevator installation process.

FIG. 6 is a cross-sectional schematic view of the example mount 100 attached to the first and second crossheads 300a, 300b of the car sling. One having ordinary skill in the art will appreciate how forces are transmitted throughout the mount 100 and the crossheads 300a, 300b as the climber motor 102 hoists the mount 100 and the car sling and hence the elevator cab 200 towards a hoist beam to which the hoist cable 240 may be secured at the top of the hoistway. The climber motor 102 exerts a force onto the lower portion 110 of the frame 104, which is transferred upwards towards the upper portion 112 of the frame 104 and the lower plate 116. The lower plate 116 pushes upwards on the sleeves 150a, 150b, 150c, 150d, which in turn push upwards on the upper plate 160. Because the upper plate 160 is secured to the crossheads 300a, 300b, the upper plate 160 exerts an upward force on the crossheads 300a, 300b. When the upward force exerted by the mount 100 and the climber motor 102 overcome their own weight and the weight of the car sling, amongst other forces acting against movement, the car sling accelerates and begins moving upward.

Although FIGS. 1-6 and the above text disclose various example apparatuses and various example methods, those having ordinary skill in the art will recognize that the example apparatuses and example methods referenced herein may be modified in a multitude of ways without departing from the scope of the present disclosure.

What is claimed is:

1. A mount for a climber motor that hoists an elevator cab within a hoistway, the mount comprising:
a frame configured to receive the climber motor, the frame having a lower portion that is supported by a base and an upper portion that is supported by the lower portion;
a lower plate that is integral with or supported by the upper portion of the frame, the lower plate configured to be positioned beneath a canopy of the elevator cab while the climber motor lifts the elevator cab in the hoistway; and
a sleeve that is supported by the lower plate, wherein the sleeve is configured to extend through the canopy and exert an upward force on a crosshead above the canopy of the elevator cab while the climber motor lifts the elevator cab in the hoistway.

2. The mount of claim 1 comprising an upper plate that is supported by the sleeve, wherein the upper plate is configured to be positioned directly underneath the crosshead while the climber motor lifts the elevator cab in the hoistway.

3. The mount of claim 1 wherein the sleeve includes an internal channel for receiving a hoist cable.

4. The mount of claim 1 comprising an upper plate that transfers the upward force from the sleeve to the crosshead while the climber motor lifts the elevator cab in the hoistway, wherein the upper plate includes an aperture configured to receive a hoist cable coupled to the climber motor.

5. The mount of claim 1 wherein the sleeve is a first sleeve, the mount comprising a second sleeve and an upper plate that is supported by the first and second sleeves, wherein the upper plate is configured to be secured to the crosshead while the climber motor lifts the elevator cab in the hoistway.

6. The mount of claim 5 comprising a first bolt disposed within the first sleeve and a second bolt disposed within the second sleeve.

7. The mount of claim 6 wherein the first and second bolts facilitate a clamping connection of the crosshead while the climber motor lifts the elevator cab in the hoistway, wherein the crosshead is clamped between the first sleeve and a first nut, wherein the crosshead is clamped between the second sleeve and a second nut.

8. A mount for a climber motor that hoists an elevator cab within a hoistway, the mount comprising:
a frame configured to receive the climber motor, the frame having a lower portion that is supported by a base and an upper portion that is supported by the lower portion;
a lower plate that is integral with or supported by the upper portion of the frame, the lower plate being positionable within the elevator cab while the climber motor lifts the elevator cab in the hoistway;
an upper plate that is positionable underneath a crosshead above the elevator cab while the climber motor lifts the elevator cab in the hoistway; and
sleeves disposed between the upper and lower plates, wherein the sleeves are configured to extend through apertures in the canopy and exert an upward force on the upper plate above the canopy of the elevator cab while the climber motor lifts the elevator cab in the hoistway.

9. The mount of claim 8 wherein the sleeves comprise a first sleeve, a second sleeve, a third sleeve, and a fourth sleeve, wherein the first, second, third, and fourth sleeves are disposed in a rectangular pattern.

10. The mount of claim 9 comprising first, second, third, and fourth bolts disposed, respectively, within the first, second, third, and fourth sleeves.

11. The mount of claim 10 wherein the first, second, third, and fourth bolts extend through corresponding apertures in the lower plate and through corresponding apertures in the upper plate.

12. The mount of claim 11 wherein the first, second, third, and fourth bolts facilitate a clamping connection of the crosshead while the climber motor lifts the elevator cab in the hoistway, wherein the crosshead is clamped between the first, second, third, and fourth sleeves and corresponding nuts that mate with the first, second, third, and fourth bolts.

13. The mount of claim 11 wherein the first and second bolts are configured to be secured to a first member of the crosshead while the climber motor lifts the elevator cab in the hoistway, wherein the third and fourth bolts are configured to be secured to a second member of the crosshead while the climber motor lifts the elevator cab in the hoistway.

14. The mount of claim 8 wherein the upper and lower plates include vertically-aligned apertures that are configured to receive a hoist cable of the climber motor.

15. A method for lifting an elevator car sling prior to installation of an elevator drive system, the method comprising:
positioning a frame of a mount with a climber motor within an elevator cab;
positioning a sleeve of the mount to extend through an aperture in a canopy of the elevator cab; and
causing the sleeve to exert an upward force onto a crosshead of the elevator car sling to lift the elevator car sling within a hoistway.

16. The method of claim 15 comprising positioning the elevator drive system above the elevator cab such that the elevator drive system is supported by the canopy prior to lifting the elevator car sling.

17. The method of claim 15 wherein the sleeve is one of a plurality of sleeves of the mount that are positioned to extend through the canopy, wherein the plurality of sleeves collectively exert the upward force to the crosshead to lift the elevator car sling, the method comprising positioning a plate of the mount between the plurality of sleeves and the crosshead prior to lifting the elevator car sling.

18. The method of claim 17 comprising, prior to lifting the elevator car sling, clamping the crosshead between the plate and a nut that mates with a bolt extending through one of the plurality of sleeves.

19. The method of claim 17 wherein prior to lifting the elevator car sling the method comprises:
clamping a first member of the crosshead between the plate and nuts that mate with bolts extending through first and second sleeves of the plurality of sleeves; and
clamping a second member of the crosshead between the plate and nuts that mate with bolts extending through third and fourth sleeves of the plurality of sleeves.

20. The method of claim 15 comprising, prior to lifting the elevator car sling, positioning bolts of the mount on two sides of the crosshead to prevent lateral movement of the mount relative to the crosshead.
